(19) United States
(12) Patent Application Publication
(10) Pub. No.: US 2020/0002826 A1
(43) Pub. Date: Jan. 2, 2020

(54) PHOTOCATALYST FOR EFFICIENT HYDROGEN GENERATION

(71) Applicant: SABIC Global Technologies B.V., Bergen op Zoom (NL)

(72) Inventors: Tayirjan Taylor ISIMJAN, Thuwal (SA); Hicham IDRISS, Thuwal (SA)

(21) Appl. No.: 16/489,146

(22) PCT Filed: Feb. 23, 2018
(86) PCT No.: PCT/IB2018/051126

§ 371 Date: Aug. 27, 2019

Related U.S. Application Data
(60) Provisional application No. 62/464,637, filed on Feb. 28, 2017.

(51) Int. Cl. C25B 11/04; C01B 3/04; C25B 1/00; C25B 1/04

(52) U.S. Cl. CPC C25B 11/0478; C25B 1/04; C25B 1/003; C01B 3/042

(57) ABSTRACT

Certain embodiments of the invention are directed to a water splitting photo electrochemical (PEC) thin film comprising metal nanostructures positioned between a CdₓZn₁₋ₓS semiconductor and a ZnO semiconductor to form a Z-scheme for total water splitting.

### CROSS REFERENCE TO RELATED APPLICATIONS

This application claims benefit to U.S. Provisional Application No. 62/464,637, filed Feb. 28, 2017, which is incorporated herein by reference in its entirety without disclaimer.

### BACKGROUND OF THE INVENTION

### A. Field of the Invention

The invention generally concerns a Z-scheme photocatalyst system that includes a metal particle that can be positioned between two semiconductor materials for use in water-splitting systems. In particular, the first semiconductor can be a CdₓZn₁₋ₓS semiconductor, where x is <1, and the second semiconductor can be a ZnO semiconductor.

### B. Description of Related Art

Developing stable and clean energy sources has attracted vast amounts of research. Despite solar being the largest energy source, only less than 0.06% of its energy is utilized for global electricity generation (Zhang et al., Chemical Society Reviews 2012, 41(6):2382-94). Although, the price of photovoltaic (PV) modules has been declining by 5-7% annually in the past ten years, developing an economically viable and scalable energy storage solution is always challenging (Rodriguez et al., Energy and Environmental Science 2014, 7(12):3828-35). Photocatalytic water-splitting (which generates energy rich molecular H₂) has been investigated as a scalable, and cost effective solar to fuel generating system (Reece et al., Science 2011, 334(6056):645-48).

Photocatalytic systems generally use semiconductor materials. Most semiconductors with suitable band structures such as TiO₂ (Fujishima and Honda, Nature 1972, 238(5358):37-38), ZnO (Kudo and Miseki, Chemical Society Reviews 2009, 38(1):253-78), SrTiO₃ (Takata et al., Journal of the American Chemical Society 2015, 137(30):9627-34), etc. have band gaps which are only active under UV light. Therefore, other semiconductors have been investigated. By way of example, cadmium sulfide-based semiconductors such as CdₓZn₁₋ₓS have been investigated due to their band gap engineering potential, and better charge mobility as compared to CdS (Li et al., ACS Catalysis 2013, 3(5):882-89). The photocatalytic activity of various morphologies of CdₓZn₁₋ₓS have been investigated, including nanoparticles (Zhang et al., Nano Letters 2012, 12(9):4584-89; Yu et al., Angewandte Chemie—International Edition 2012, 51(4):897-900), nanotwins (Liu et al., Energy &Environmental Science 2011, 4(4):1372-78), nano-flowers (Xiong et al., Nanoscale Research Letters 2013, 8(1):1-6) and volvox-like structures (Zhou et al., Chemistry—An Asian Journal 2014, 9(3):811-18). Despite the suitable band gap and high quantum efficiency, these types of CdS based photocatalysts suffer from catalytic decay even with sacrificial reagents because the sulfide is easily oxidized to elemental sulfur by photogenerated holes. Lingampalli et al., has reported that [ZnO]₄/Pt/Cd_{0.8}Zn_{0.2}S hetero-junction structures show an apparent quantum yield of 50% in the 395-515 nm region (Lingampalli et al., Energy and Environmental Science 2013, 6(12):3589-94). These results imply that the metal nano particles located between two nano-crystals accelerated the charge separation in the Z-scheme (See, Tada et al., Nature Materials 2006, 5(10):782-86; Yu et al., Journal of Materials Chemistry A 2013, 1(8):2773-76). However, this system is not stable over the long term for two reasons: (1) ZnO is only stable in a narrow pH range (pH 6-8) (See, Colloids and Surfaces A: Physicochemical and Engineering Aspects 2014, 451 (1), 7-15, The Science of the total environment 2014, 468-469, 195-201 and ACS Applied Materials and Interfaces 2014, 6 (1), 495-499), whereas the ideal pH for hydrogen production, either by sacrificial or direct water-splitting, is outside of that range; and (2) the original Z-scheme structure can be gradually destroyed following the dissolution of the ZnO which subsequently causes the decomposition of Cd_{0.8}Zn_{0.2}S.

For at least the reasons discussed above, there remains a need for additional photocatalyst that are more stable and efficient.

### SUMMARY OF THE INVENTION

A solution that addresses at least some of the above-discussed problems associated with photocatalysts (e.g., holes from CdS based light absorbers) has been discovered. The solution is premised on methods and compositions that effectively remove holes from CdS based light absorbers providing photocatalysts with longer term stability. Without wishing to be bound by theory, it is believed that no single semiconductor can fulfill the requirements of (i) suitable band gap energy of 1.8-2.4 eV, which is the optimal energy band positions for total water-splitting using sun light, (ii) high quantum yield, (iii) long term stability under photocatalytic conditions, and (iv) energy band edges positions suitable for the redox reaction to occur. Therefore, integration of metal oxide or carbon nitride semiconductor material (because of their stability) with a Cd-based semiconductor material (because of their efficiency) offers a potential solution. These integrated systems can be poised to not only provide more efficient charge transfer, but also prolong the life time of the charge carriers.

The effective Z-scheme of the photocatalyst of the present invention can remove the photo-generated hole from a CdₓZn₁₋ₓS (x<1) based catalyst, which can result in a stable hybrid system. Furthermore, the hybrid systems described herein have several advantages. First, the preparation method is simple and straightforward. Second, the oxide semiconductors are stable and the photo corrosion issue of Cd(M)S can be addressed by efficiently quenching the hole generated on Cd(M)S through a Z-scheme. Third, most of the materials required are relatively inexpensive and easily available with some of the noble metals replaceable by other non-noble metals without compromising the photocatalytic efficiency.

Certain embodiments of the invention are directed to a water splitting photo electrochemical (PEC) thin film comprising metal nanostructures (e.g., nanoparticles) positioned between a first semiconductor and a second semiconductor to form a Z-scheme for total water splitting, the first semiconductor can be a CdₓZn₁₋ₓS semiconductor, where x is less than 1 (e.g., 0.01 to 0.99, or 0.7 to 0.9), and the second semiconductor can be a ZnO semiconductor. The metal nanostructure can include a transition metal (M1), (e.g., a Columns 9-11 of the Periodic Table). In certain aspects the metal nanostructures can include Ni, Cu, Fe, Au, Pt, Pd, or Ag. In a further aspect the metal nanoparticle can be Fe, Cu, Au, Pt, Pd, Ag, Au/Ni, Au/Pd, Au/Cu, Ag/Ni, Ag/Pd, or Ag/Cu nanoparticle. The metal nanoparticles can be a core-shell nanoparticle of two metals. In certain aspects the metal nanostructure is a nanoparticle that includes Cu, Fe, Au, Pt, Pd, Ni, Ag, alloys of two or three metals, or a core-shell nanoparticle of two metals. In certain aspects the ZnO to nanostructure ratio can be 50:1, 100:1, 500:1, to 1000:1, including all ratios and ranges there between. In particular aspects the ZnO to S ratio can be 4:1 to 1:2. The Cd:Zn ratio can range from 1:9 to 9:1, preferably 0.8:1 to 0.85:1, or about 0.82:1

Other embodiments are directed to a photocatalytic reactor, the reactor having an inlet for feeding water or aqueous solution to a reactor chamber, the reactor chamber comprising (i) a photoelectrochemical (PEC) assembly comprising a PEC thin film that includes the Z-scheme photocatalyst of the present invention. In certain aspects the PEC film has metal nanostructure positioned between a CdₓZn₁₋ₓS semiconductor and a ZnO semiconductor. The reactor can include a H₂ gas product outlet and O₂ gas product outlet. In certain aspects, the reactor chamber is transparent to visible light. In a further aspect the CdₓZn₁₋ₓS semiconductor can be deposited on a conductive support. The conductive support can have a base or base coat of a hydrogen catalyst composed of Pt, Pd, Au, Ag, Ir, Ru, Rh, Mo, Ni, Ce, Co, Fe, W and Sn as well as their combinations of any kind, such as Mo/Ni in a ratio of 10:1 to 1:10. In certain aspects selected metals can be present at a ratio of 10:1 to 1:10, including all ratios (e.g., 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, to 1:10) and ranges there between The conductive support can include stainless steel, Molybdenum, Titanium, Tungsten, or Tantalum. The ZnO semiconductor can further include a hole transporting thin film. In certain aspects the oxygen co-catalyst can be a metal oxide (AO_{y}) or (A_{z}B_{1-z}O_{y}) where z<1 and y is a value sufficient to balance the valence of the metal. The metals (A) and/or (B) can be Pt, Pd, Au, Ag, Ir, Ru, Rh, Mo, Ni, Ce, Co, Fe, W and Sn as well as their combinations of any kind, such as nickelate (IrNiO₃).

Certain embodiments are directed to a system for hydrogen production using the Z-scheme photocatalyst of the present invention. The system can include (a) a photocatalytic reactor as described herein; (b) a hydrogen storage chamber, (c) oxygen storage chamber, (d) thin film for water splitting and (e) ion exchange membrane.

Further embodiments are directed to methods of producing hydrogen that include irradiating a photo electrochemical (PEC) thin film with light in the presence of water. The PEC thin film can include one or more of the photocatalysts of the present invention.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions the invention can be used to achieve methods of the invention.

The following includes definitions of various terms and phrases used throughout this specification.

The phrase “Z-scheme photocatalytic water-splitting” refers to a two-step photoexcitation process using two different semiconductors and a reversible donor/acceptor pair or shuttle redox mediator. In photocatalytic Z-scheme water-splitting two semiconducting materials with different band gaps are used to (1) absorb larger fractions of the solar light spectrum and (2) to drive the proton reduction reaction (hydrogen evolution) and the oxygen anion oxidation reaction at different particles. In this approach, molecular hydrogen and oxygen can be produced separately resulting in overall lower hydrogen production costs.

Nanostructure” or “nanomaterial” refer to an object or material in which at least one dimension of the object or material is equal to or less than 1000 nm (e.g., one dimension is 1 to 1000 nm in size), preferably equal to or less than 100 nm. In a particular aspect, the nanostructure includes at least two dimensions that are equal to or less than 1000 nm (e.g., a first dimension is 1 to 1000 nm in size and a second dimension is 1 to 1000 nm in size), preferably equal to or less than 100 nm. In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size), preferably equal to or less than 100 nm. The shape of the nanostructure can be of a wire, a particle (e.g., having a substantially spherical or spherical shape), a rod, a tetrapod, a hyper-branched structure, a tube, a cube, or mixtures thereof. “Nanoparticles” include particles having an average diameter size of 1 to 1000 nanometers, preferably 1 to 100 nm.

The term “semiconductive material”, “semiconductor,” or “semiconducting substrate” and the like is generally used to refer to elements, structures, or devices, etc. that include materials that have semiconductive properties, unless otherwise indicated.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The use of the term “or” in the claims is used to mean “and/or” unless explicitly indicated to refer to alternatives only or the alternatives are mutually exclusive, although the disclosure supports a definition that refers to only alternatives and “and/or.”

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the catalysts of the present invention are their abilities to photocatalyze water-splitting.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 depicts a schematic of a non-limiting synthesis of ZnO/M1/CdₓZn₁₋ₓS of the present invention.

FIG. 2 depicts a schematic of a water-splitting system of the present invention that include the ZnO/M1/CdₓZn₁₋ₓS Z-scheme photocatalysts of the present invention.

FIG. 3A depicts X-ray diffraction patterns for the hhe hybrid system show mixtures of hexagonal ZnO and cubic Cd0.7Zn_{0.3}S phases.

FIG. 3B depict XRD patterns of Cd_{0.8}Zn_{0.2}S-based systems (top to bottom): CdS cubic (top), ZnS hexagonal, Cd_{0.8}Zn_{0.2}, 1 wt. % Pt/Zn, 1 wt. % Pt/Cd_{0.8}Zn_{0.2}S, and [ZnO]₄/1 wt. % Pt/Cd_{0.8}Zn_{0.2}S (bottom).

FIG. 4A depicts. UV-vis absorption spectra of Cd_{0.7}Zn_{0.3}S based materials. Inset: Tauc plots of the Cd_{0.7}Zn_{0.3}S based materials.

FIG. 4B depicts UV-vis absorption spectra of Cd_{0.8}Zn_{0.2}S-based materials. Inset: Tauc plots of the Cd_{0.8}Zn_{0.2}S-based materials.

FIGS. 5A-D depict transmission electron microscopy images of [ZnO]_{4/}0.1% Pt/Cd_{0.8}Zn_{0.2}S. (5A) low-magnification; (5B) high-magnification with Fourier Transform analysis; (5C) high-magnification image with selected area electron diffraction pattern (SAED), arrows indicate Pt entities; (5D) HAADF-STEM image with EDX analysis corresponding to the area inside the white square.

FIGS. 6A-6D depict XPS spectra of ZnO/Pt/Cd_{0.8}Zn_{0.2}S system: (6A) S2p; (6B) Pt4f; (6C) Cd3d; and (6D) Zn2p.

FIG. 7 depicts a bar graph of hydrogen generation rates of ZnO/Pt/Cd(Zn)S with various compositions (left to right): 1) ZnO/0.1 wt. % Pt/Cd_{0.9}Zn_{0.1}S; 2) [ZnO]₅/1 wt. % Pt/Cd_{0.9}Zn_{0.1}S; 3) [ZnO]₅/0.1 wt. % Pt/Cd_{0.12}n_{0.9}S; 4) [ZnO]_{1/}1 wt. % Pt/Cd_{0.9}Zn_{0.2}S; 5) [ZnO]₁/0.1 wt. % Pt/Cd_{0.1}Zn_{0.9}S; 6) [ZnO]₅/0.1 wt. % Pt/Cd_{0.9}Zn_{0.1}S; 7) [ZnO]₁/1 wt. % Pt/Cd_{0.1}Zn_{0.9}S; and 8) [ZnO]₅/1 wt. % Pt/Cd_{0.1}Zn_{0.9}S.

FIG. 8 depicts a bar graph of rate of photocatalytic hydrogen generation of Cd_{0.8}Zn_{0.2}S-based photo-catalysts in an aqueous solution of benzyl alcohol and acetic acid (2.5-2.5 v/v %) under 42.5 mW/cm² of Xenon lamp.

FIG. 9 shows moles of H₂/g_{cat} over time for the Pd—Au, Pt, Ag Cd(Zn)S of the present invention.

FIGS. 10A and 10B depict a schematic of a charge transfer mechanism of ZnO/Pt/Cd_{0.8}Zn_{0.2}S system: (10A) Z-scheme under UV, (10B) Charge separation under visible light.

FIGS. 11A and 11B depict femtosecond transient adsorption data: (11A) fs Transient absorption spectra of CdZnS, Pt/CdZnS, ZnO, Pt/ZnO, and ZnO/Pt/CdZnS in water at different time delay following 350 nm lase excitation and (11B) Normalized kinetics traces monitored at key wavelength of ZnO, Pt/ZnO, and ZnO/Pt/CdZnS and normalized kinetic decay traces of ZnO, Pt/ZnO, and ZnO/Pt/Cd_{0.8}Zn_{0.2}S in 0.5 mg/ml water suspension following 350 nm excitation with 90 μJ/cm².

### DETAILED DESCRIPTION OF THE INVENTION

A solution to at least some of the problems associated with light harvesting associated with photocatalytic systems has been discovered. The solution is premised on an integrated photocatalyst that shows a redox potential scheme corresponding to the Z-scheme, the total potential difference of which is sufficient to permit cleavage of water into hydrogen and oxygen when the catalyst is irradiated with light (e.g., sun light) that includes a wavelength of at least 420 nm, 430 nm, 440 nm, 450 nm, and up to 700 nm. An integrated photocatalyst described herein can be in the form of a plate, a film, or a tube. In certain aspects the integrated photocatalyst is a photo electrochemical (PEC) thin Film. A water splitting PEC thin film described herein can comprise metal nanoparticles positioned between a first semiconductor and a second semiconductor to form a Z-scheme for total water splitting.

Semiconductor materials can include: elements from Column 4 of the Periodic Table; materials including elements from Column 3 and Column 5 of the Periodic Table; materials including elements from Columns 2 and 4 of the Periodic Table; materials including elements from Columns 1 and 7 of the Periodic table; materials including elements from Columns 4 and 6 of the Periodic Table; materials including elements from Columns 5 and 7 of the Periodic Table; and/or materials including elements from Columns 2 and 5 of the Periodic Table. Other materials with semiconductive properties can include layered semiconductors, metallic alloys, miscellaneous oxides, some organic materials, and some magnetic materials.

First semiconductor—In certain aspects, the first semiconductor can include cadmium-based materials having a band gap that from 1.7 to 2.8 eV, or 2.0 to 2.5, or 2.1 to 2.3 eV, or any range or value there between. In certain aspects a first semiconductor is a CdₓZn₁₋ₓS (2.4 eV) semiconductor, where x is less than 1, from 0.01 to 0.99, from 0.7 to 0.9, or any value at least, equal to, or between any two of 0.01, 0.05, 0.1, 0.15, 0.2, 0.25, 0.3, 0.35, 0.4, 0.45, 0.5, 0.55, 0.6, 0.65, 0.70, 0.75, 0.8, 0.81, 0.82, 0.83, 0.84, 0.85, 0.9, 0.95, and 0.99, but less than 1. In one embodiment the Cd:Zn molar ratio is 1:9 to 9:1, or 1:9, 1:8, 1:7, 1:5, 1:1, 2:1, 3:1, 3.5:1, 4:1, 4.5:1, 5:1, 5.5:1, 6:1, 7:1, 8:1, 9:1 or any range or value there between. In a preferred embodiment x is about 0.82.

Second semiconductor—A second semiconductors is a semiconducting material with a wider band gap that the first semiconductor, that is for example from 2.4-3.2 eV. Non-limiting examples of semiconductors include ZnO, TiO₂, SrTiO₃ and BiVO₄. In certain aspects the second semiconductor is ZnO.

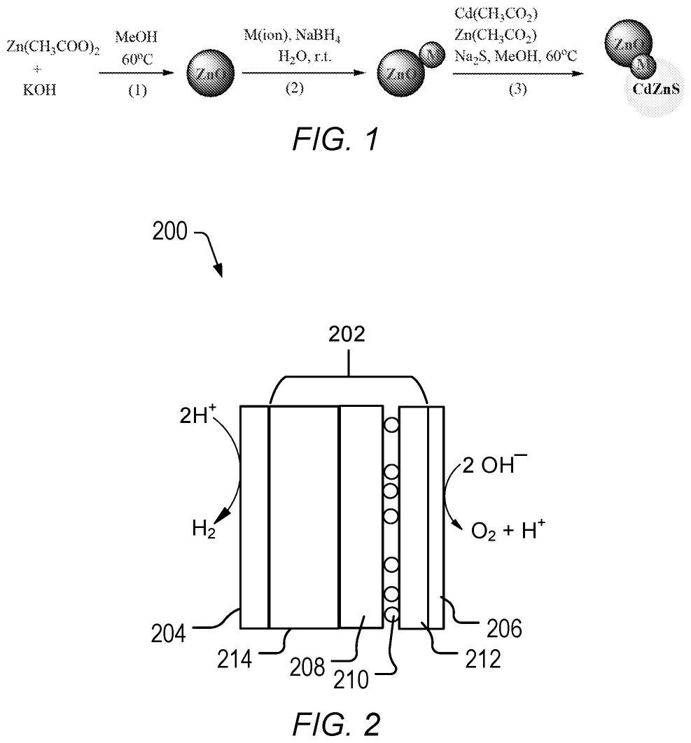

Metal nanoparticles—The amount of M1 loading in the Z-scheme catalysts can be from 0.05 wt. % to 1 wt. %, or 0.1 wt. % to 0.8 wt. %, or at least, equal to, or between any two of 0.05 wt. %, 0.1 wt. %, 0.15 wt. %, 0.2 wt. %, 0.3 wt. %, 0.4 wt. %, 0.5 wt. %, 0.6 wt. %, 0.7 wt. %, 0.8 wt. %, 0.9 wt. %, and 1 wt. %. In some embodiments, the nanostructures are nanoparticles. The present invention provides the advantage of using less expensive metals (Ag, Pd, Cu, and Ni) as well as bimetallic systems (Au/Ni, Ag/Ni, Au/Pd, Ag/Pd, Au/Cu and Ag/Cu). The preparation of the Z-scheme catalyst can be done using known catalysts preparation methods. Referring to FIG. 1, which depicts a non-limiting schematic for the synthesis of the ZnO/M1/CdZnS photocatalyst of the present invention. In a first step, zinc oxide material can be obtained or made from a zinc precursor material. For example, an alcoholic solution of zinc acetate, base (potassium hydroxide) can be stirred at 50 to 100° C., or 55 to 75° C. for a desired amount of time to produce the zinc oxide material. The metal nanostructures can be deposited on the ZnO semiconductor material to form a M1/ZnO semiconductor material. By way of example, a metal precursor solution can be added to an alcoholic suspension of the ZnO semiconductor particles. A reducing action can be added to the solution and the solution agitated at 20 to 35° C. or room temperature until the metal precursor material forms a zero valent metal. The resulting particles can be isolated (e.g., centrifugation) and dried to give a M1@ZnO semiconductor material. The M1@ZnO semiconductor material can be dispersed in an alcoholic solution and heated to an appropriate temperature (e.g., 55 to 65° C.). A Zn precursor of the CdZnS series (first semiconductor material) can be added to the heated alcoholic dispersion of the M1@ZnO material. A cadmium metal precursor can be an alcoholic solution, and a reducing agent (e.g., sodium sulfide) can be added to the metal precursor/M1@ZnO dispersion. The solution can be agitated for a period of time and the resulting ZnO@M1@CdMS material can be isolated, washed with an aqueous methanol solution, and the then dried at 50 to 75° C. to yield the final ZnO/M1@CdₓZn₁₋ₓS material. In some embodiments, the CdZnS material is formed and then added to the M1/second semiconductor material. As shown in FIG. 1, the CdMS forms a shell over M1 which is on the surface of the ZnO. In certain aspects the catalyst was optimized for an improved hydrogen generation rate of a ZnO/M1/CdₓZn₁₋ₓS. Changing the ratio of ZnO to Cd(Zn)S as well as the ratio (x/(1−x)) of Cd(Zn)S with the objective of identifying a catalyst for photocatalytic hydrogen generation.

The Z-scheme photocatalysts of the present invention can be used in a water-splitting system that include a hydrogen co-catalyst and an oxygen co-catalyst. FIG. 2 depicts a schematic of a water-splitting catalyst system 200. System 200 can include water-splitting systems that include the Z-scheme photocatalyst of the present invention 202 in combination with a hydrogen co-catalyst 204 and an oxygen co-catalyst 206. The Z-scheme photocatalyst 202 can be a multi-layer film that is electrically and photo active (e.g., a PEC film). Z-scheme photocatalyst can include first semiconductor material (e.g., CdₓZn₁₋ₓS) 208, metal nanostructure 210, and second semiconductor material (e.g., ZnO) 212. First semiconductor material 208 can have a thickness of 100 nm to 5000 nm, 500 nm to 3000 nm, or 1000 nm to 2000 nm or any value or range there between. Metal nanostructure 210 can have a size of 0.5 nm to 20 nm, 1 nm to 10 nm, 2 nm to 5 nm or about 3 nm or any value or range there between. Second semiconductor layer 212 can have a thickness of 10 to 500 nm, 50 to 400 nm, or 100 to 300 nm or about 200 nm. In some instances, first semiconductor material 202 can have a thickness of 2000 nm, the metal nanostructure can be 3 nm, and the second semiconductor can have a thickness of 20 nm. Z-scheme photocatalyst 202 can be deposited on conducting support material 214 (e.g., a stainless steel support).

Hydrogen co-catalyst 204 can be deposited on a second portion of support material 214 opposite of Z-scheme photocatalyst 202. A thickness of hydrogen co-catalyst can be 0.01 to 50 nm, 1 to 30 nm or 5 to 15 nm, or any value or range there between, or about 10 nm. The hydrogen generation catalyst can have two metals at a ratio of 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, to 1:10. Non-limiting examples of hydrogen production co-catalysts can include Pt, Pd, Au, Ag, Ir, Ru, Rh, Mo, Ni, Ce, Cu, Co, Fe, W and Sn as well as combinations thereof (e.g., Mo:Ni catalyst in a 1:1 weight ratio). In certain aspect, the Mo/Ni hydrogen catalyst can have a Mo:Ni a ratio of 10:1 to 1:10, including all values and ranges there between.

Oxygen producing co-catalyst 206 can be deposited on a portion of the second semiconductor 212 (e.g., metal oxide or carbon nitride material). A thickness of oxygen producing co-catalyst 206 can be 0.01 to 50 nm, 1 nm to 40 nm or 10 to 30 nm, or any range or value there between, or about 30 nm. Oxygen co-catalyst 206 can be a metal oxide (AO_{y}) or (A_{z}B_{1-z}O_{y}) where z<1 and y is a value sufficient to balance the valence of the metal. The metals (A) and/or (B) can be Pt, Pd, Au, Ag, Ir, Ru, Rh, Mo, Ni, Cu, Co, Fe, W, Sn, and combinations thereof. The metals can be deposited, for example, on ZnO/M1/CdₓZn₁₋ₓS by the “light deposition, electrochemical deposition, pulse laser deposition and chemical vapor deposition methods.” A wireless total water splitting system can be fabricated using a ZnO/M1/CdₓZn₁₋ₓS base.

An apparatus or system for the production of hydrogen from water or aqueous solutions of organic compounds by using the Z-Scheme photocatalyst of the present inventions or apparatus described herein can include one or more of (i) a light source (such as a visible light source), (ii) a reactor (optionally a transparent portion for light if the “light source” is external to the reactor), (iii) an inlet for feeding water or aqueous solution to the reactor, and (iv) a gas product outlet for releasing hydrogen liberated in the reaction chamber. The photocatalyst described herein can be located inside the reactor. The apparatus or system for the production of hydrogen can also include a storage chamber for collecting and storing the molecular hydrogen produced. The storage chamber can be in communication with the reaction chamber via the gas or product outlets. The storage chamber may be pressurized.

Valves may also be present, to control the flow of water or aqueous solution into the reactor via the inlet and release of gas via the outlet. Control means may also be present to adjust the light source intensity or even switch it on or off (e.g., provide access or block sunlight) as required. The reaction chamber or reactor may further comprise a waste outlet for removal of waste or by-products or unreacted water or aqueous solution, the waste outlet optionally having a valve. Still further, the hydrogen production device may comprise control means operably linked to the valves for controlling the flow of water or aqueous solution into the reaction chamber, the flow of molecular hydrogen through the outlet (and into the storage chamber if present), and/or the flow of waste or by-products or unreacted water or aqueous solution through the waste outlet.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Stock solution used in the Examples are listed in Table 1.

TABLE 1

| | MW | Mass | | V(mL) in | Molar | Purity |
|---|---|---|---|---|---|---|
| Chemicals | (g/mol) | (g) | Mole (mmol/ml) | MeOH | conc. | (%) |
| Zn(CH₃CO₂)•2H₂O | 220 | 1.76 | 0.08 | 100 | 0.08M | 99 |
| Cd(CH₃CO₂)•2H₂O | 266.5 | | 0.08 | 100 | 0.08M | 99 |
| Na₂S•xH₂O | 78 | 1.3 | 0.1 | 100 | 0.1M | 60 |
| KOH | 56 | 1.5 | | 30 | | 99 |
| NaBH₄ | 38 | 0.152 | 0.04 | 100 | 0.04M | 99 |
| HAuCl₄•3H₂O | 393.8 | 0.394 | 0.01 (1.9 | 100 | 0.01M | 99 |
| | | | mg (Au)/mL) | | | |
| AgNO₃ | 169.8 | 0.79 | 1 mg (Ag)/mL | 500 | 0.0093M | 99 |
| H₂PtCl₆•6H₂O | 409 | 0.961 | 1.9 mg (Pt)/mL | 200 | 0.012M | 99.9 |

### Example 1

### Synthesis of ZnO

Zn(CH₃COO)₂.2H₂O (2.64 g, 12 mmol) was added to methanol (210 mL) in a 500 mL 3 neck RBF and the temperature was raised to about 60° C. After 10 minutes, methanolic solution of KOH (1.50 g, 26.7 mmol) in 30 mL of water was added drop wise to the reaction solution while stirring and then the stirring was continued for 2 h at 60° C. The color of the solution became turbid at the initial stages and then changed to colorless after 30 min. After 2 h, the solution slowly turned to white color (the particle size also depends on the size of the magnetic bead and rpm of stirring e.g., 600 rpm). Formed ZnO nanoparticles were precipitated out by addition of water and the excess ions were removed by centrifugation. The resulting product was washed with methanol and dried at about 60° C. for 2 hours to give ZnO.

### Example 2

### Synthesis of M1 on ZnO

Synthesis of Au@ZnO. HAuCl₄ (1.97 mg (Au)/mL, 1.7 mL) was added drop-wise to a methanolic solution of ZnO (0.33 g, 4.1 mmol) nanocrystals, followed by 5 mL of NaBH₄ (40 mM) aqueous solution. The solution was stirred for 10 min. The solution color became black due to the formation of gold on ZnO nanoparticles. The resulting solution was centrifuged, filtered and dried in air to give Au@ZnO.

Synthesis of Ag@ZnO. HAgCl₄ (1 mg (Ag)/mL, 4 mL) was added drop-wise to a methanolic solution of ZnO (0.33 g, 4.1 mmol) nanocrystals, followed by 5 mL of NaBH₄ (40 mM) aqueous solution. The solution was stirred for 10 min. The solution color became black due to the formation of silver on ZnO nanoparticles. The resulting solution was centrifuged, filtered and dried in air to give Ag@ZnO.

Synthesis of Au/Pd@ZnO. A mixture of HAuCl₄ (1.97 mg (Au)/mL, 0.76 mL) and PdCl2 (1.2 mg (Pd)/mL, 1.3 mL) was added drop-wise to a methanolic solution of ZnO (0.33 g, 4.1 mmol) nanocrystals, followed by 5 mL of NaBH₄ (40 mM) aqueous solution. The solution was stirred for 10 min. The solution color became black due to the formation of Pd—Au on ZnO nanoparticles. The resulting solution was centrifuged, filtered and dried in air to give Au—PD@ZnO.

Synthesis of Pt@ZnO. H₂PtCl₆6H₂O (1 mg (Pt)/mL, 12 mL or 0.1 mg (0.12 mL for 0.1 wt. %) was added drop-wise to a methanolic suspension of Zn (1 g, 12.3 mmol) nanocrystals, followed by 1.5 mL of NaBH₄ (40 mM) aqueous solution. The solution was stirred for 10 min. The solution color became black due to the formation of platinum on ZnO nanoparticles. The resulting solution was centrifuged, filtered and dried in air to give Pt (1 wt %) @ ZnO2.

### Example 3

### Synthesis of ZnO₂@M1@Cd_{0.8}Zn_{0.2}S Compounds

Zn/M1 (0.2 g, 2.5 mmol) nanoparticles of Example 2 were re-dispersed in 70 mL methanol and the temperature was raised to 60° C. In order to form Cd_{0.8}Zn_{0.2}S layer of the particles, zinc acetate (0.5 mmol) from zinc acetate stock solution (80 mM, 6.25 mL) was added to the dispersion and then the cadmium acetate (2 mmol) from (80 mM, 25 mL) stock solution and sodium sulfide (3 mmol) from (100 mM, 30 mL) methanolic stock solutions were added drop wise simultaneously while stirring the solution. Stirring was continued for 30 min more. Products were separated by centrifugation and washed with H₂O/MeOH mixture and dried at 60° C. overnight to give the final product.

ZnO/Pt/Cd_{0.8}Zn_{0.2}S. ZnO/Pt (0.32 g, 4 mmol) nanoparticles were dispersed in 70 mL methanol and temperature was raised to 60° C. In order to form Cd_{0.8}Zn_{0.2}S layer on the particles, the required amount of zinc acetate (0.2 mmol) from zinc acetate stock solution (80 mM, 2.5 mL), the cadmium acetate (0.8 mmol) from (80 mM, 10 mL) stock solution were added to the suspension and stirred for 15 min at 60° C. then sodium sulfide (2 mmol) from (100 mM, 20 mL) methanolic stock solution was added dropwise. The resulting suspension was stirred for 1 h. The precipitates were separated by centrifugation, washed with H₂O/MeOH (1:1) mixture and dried at 80° C. overnight to give the final product of [ZnO]₄/1 wt. % Pt/Cd_{0.8}Zn_{0.2}S (0.4 g, 88% in yield).

Pt/Cd_{0.8}Zn_{0.2}S. Zinc acetate (0.2 mmol) from zinc acetate stock solution (80 mM, 2.5 mL), the cadmium acetate (0.8 mmol) from (80 mM, 10 mL) stock solution were mixed and stirred for 15 min at 60° C. then sodium sulfide (2 mmol) from (100 mM, 20 mL) methanolic stock solution was added dropwise. The resulting suspension was stirred for 1 h. The precipitates were separated by centrifugation, washed with H₂O/MeOH (1:1) mixture, and dried at 60° C. overnight to give the final product of Cd_{0.8}Zn_{0.2}S in quantitative yield. Photo deposition of Pt on Cd_{0.8}Zn_{0.2}S was carried out by mixing of Cd_{0.8}Zn_{0.2}S (100 mg) with 1 mL stock solution of H4PtCl₆ (1 mg/mL (Pt)) in BnOH/AcOH (2.5-2.5 v/v %). The resulting mixture was illuminated under UV (λ=360 nm) light with a light intensity of 5 mW/cm² for 4 h. The resulting solution was filtered, washed with water, and dried at 80° C. overnight to obtain the desired product 1 wt. % Pt/Cd_{0.8}Zn_{0.2}S in quantitative yield.

### Example 4

### Characterization

UV-vis absorption spectra of the powdered catalysts were collected over the wavelength range of 250-700 nm on a Thermo Fisher Scientific (USA) spectrophotometer equipped with praying mantis diffuse reflectance accessory. Absorbance (A) and reflectance (% R) of the samples were measured. The reflectance (% R) data were used to calculate the band gap of the samples using the Tauc plot (Kubelka-Munk function). XRD spectra were recorded using a Bruker D8 Advance X-ray diffractometer Cu Kα (λ=1.5406 \acute{Å} ) radiationover the range of 2θ interval between 20 and 90° with a step size of 0.010° and a step time of 0.2 s/step were used. The XP spectra of the samples were collected by a Thermo Scientific Escalab 250 XI XP spectrometer with Al Kα X-ray source. The X-ray spot size was 650 μm². The charge compensation was carried out using a standard flood gun. Before collecting XPS data, samples were etched using Ar ions for 5 min at ion energy of 1000 eV. The data was acquired using the following settings listed in Table 2 before and after etching. All the peaks were corrected respect to the binding energy of adventitious C1s peak at 284.5 eV. All peaks were fitted using SMART background option and Lorentzian/Gaussian.

TABLE 2

| | | | | # of |
|---|---|---|---|---|
| Scan | PE (eV) | Dwell Time (ms) | Step Size (eV) | scans |
| Survey | 100 | 100 | 1 | 1 |
| High Resolution | 30 | 100 | 0.1 | 10-30 |

The concentrations of Zn, Cd, S and Pt were measured by ICP-OES on a Varian 720-ES instrument. TEM samples were dispersed in alcohol and a drop of the suspension was placed over a grid with holey-carbon film. The TEM images were collected using a FEI Tecnai F20 microscope operating at 200 kV.

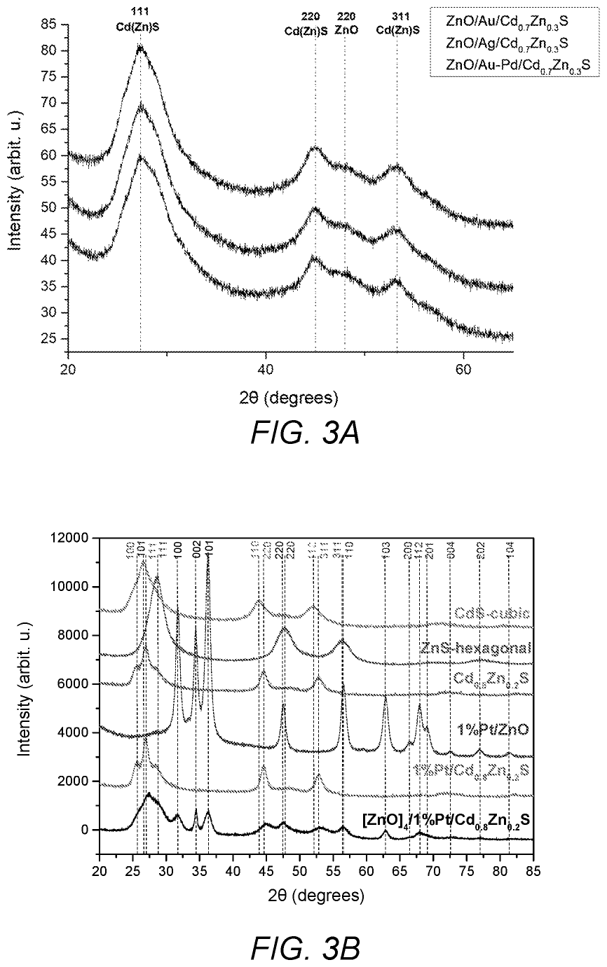

XRD analysis. XRD patterns of various compositions are depicted in FIGS. 3A and 3B. The hybrid system show mixtures of hexagonal ZnO and cubic Cd_{0.7}Zn_{0.3}S phases for ZnO/Au—Pd/Cd_{0.7}Zn_{0.3}S (bottom pattern), ZnO/Au/Cd_{0.7}Zn_{0.3}S (middle pattern) ZnO/Ag/Cd_{0.7}Zn_{0.3}S (top pattern) as shown in FIG. 3A. FIG. 3B is the XRD patterns of XRD patterns of Cd_{0.8}Zn_{0.2}S based systems from top to bottom CdS cubic (top pattern), ZnS hexagonal (next to top pattern), Cd_{0.8}Zn_{0.2}S (below ZnS pattern), 1% Pt/ZnO (below Cd_{0.8}Zn_{0.2}S pattern), 1% Pt/Cd_{0.8}Zn_{0.2}S (above bottom pattern) and, [ZnO]₄/1% Pt/Cd_{0.8}Zn_{0.2}S (bottom pattern).

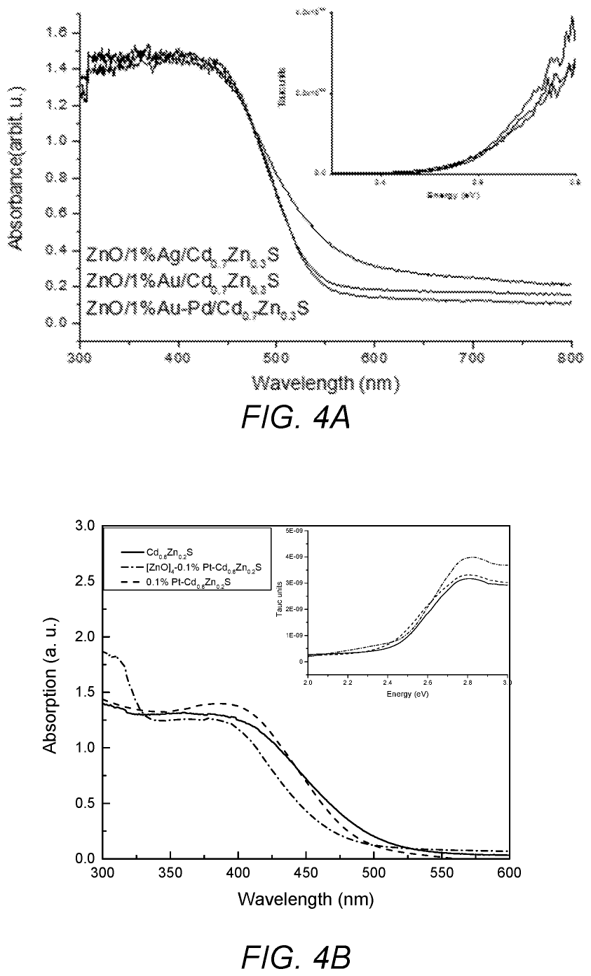

UV-Vis analysis. FIGS. 4A and 4B presents UV-vis diffused reflectance spectra of the solid solutions. The intense absorption bands with steep edges are observed which indicates that the light absorption is due to intrinsic band gap transitions. Kubelka-Munk function versus energy of incident light are shown in the inset of FIGS. 4A and 4B. For the ZnO/Au—Pd/Cd_{0.7}Zn_{0.3}S (bottom pattern), ZnO/Au/Cd_{0.7}Zn_{0.3}S (middle pattern) ZnO/Ag/Cd0.7Zn_{0.3}S (top pattern). The band gap position is almost the same, around 2.5 eV for these systems. FIG. 4B shows the comparative systems of 1% Pt/Cd_{0.8}Zn_{0.2}S (bottom pattern) Cd_{0.8}Zn_{0.2}S (middle pattern) and, [ZnO]₄/1% Pt/Cd_{0.8}Zn_{0.2}S (top pattern). The band gap position is between 2.2 to 2.3 eV for these systems.

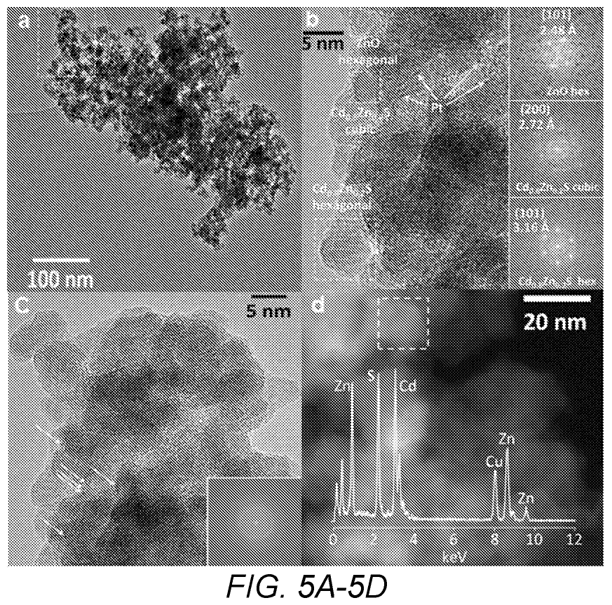

TEM Analysis. FIGS. 5A-D shows TEM images an overall view of the [ZnO]₄/Pt/Cd_{0.8}Zn_{0.2}S as prepared, which was constituted by small particles quite homogeneous in size. An enlargement of the area inside the square in FIG. 5A showed a very homogeneous distribution of particles with an average particle size of 5 nm (Cd_{0.8}Zn_{0.2}S), which was slightly smaller than that of estimated by XRD (FIG. 3B). It is interesting to note, however, that particles with different crystallinity are seen, ranging from almost amorphous to very well faceted ones. This is particularly visible in the inserts of the Fourier Transform image (FT) of the particle of FIG. 5B. Spots at 3.36 and 3.16 Å were attributed to the (002) and (101) crystallographic planes of hexagonal Cd_{0.8}Zn_{0.2}S while the spots at 2.72 and 3.14 Å were attributed to (200) and (111) planes of cubic crystal phase, respectively. Furthermore, the (101) plane of hexagonal ZnO was also observed. In FIG. 5C, several small particles with high electron contrast (marked by arrows) can be ascribed to a Pt-containing phase. They were sub-nanometric and very well dispersed. HAADF-STEM was performed in order to study the microstructure of the catalyst. The EDX analysis showed strong signals of Zn, Cd and S, and were attributed to the mixed phases of ZnO and Cd_{0.8}Zn_{0.2}S. Both phases were extremely well mixed. XPS survey spectra (not shown) of 0.1 wt. % Pt/Cd_{0.8}Zn_{0.2}S, 1 wt. % Pt/Cd_{0.8}Zn_{0.2}S, [ZnO]₄/0.1 wt. % Pt/Cd_{0.8}Zn_{0.2}S and [ZnO]₄/1 wt. % Pt/Cd_{0.8}Zn_{0.2}S, confimred the coexistence of Cd, Zn, S, and Pt. The binding energies of Cd3d_{5/2}, Zn2p_{3/2}, S2p_{3/2} and O1s are recorded in Table 3.

TABLE 3

| | | | | | O1s | O1s | O1s |
|---|---|---|---|---|---|---|---|
| Samples | Cd3d_{5/2} | Zn2p_{3/2} | S2p_{3/2} | Pt4f_{7/2} | (ZnO) | (OH) | (H₂O) |
| 0.1% Pt/Cd_{0.8}Zn_{0.2}S | 404.8 | 1022.1 | 161.1 | 72.0 | | 531.3 | 532.9 |
| 1% Pt/Cd_{0.8}Zn_{0.2}S | 404.8 | 1022.1 | 161.1 | 71.9 | | 531.6 | 533.0 |
| [ZnO]₄/0.1% Pt/Cd_{0.8}Zn_{0.2}S | 404.7 | 1022.0 | 161.0 | — | 530.0 | 531.5 | — |
| [ZnO]₄/1% Pt/Cd_{0.8}Zn_{0.2}S | 404.8 | 1022.4 | 161.2 | — | 530.3 | 531.7 | — |

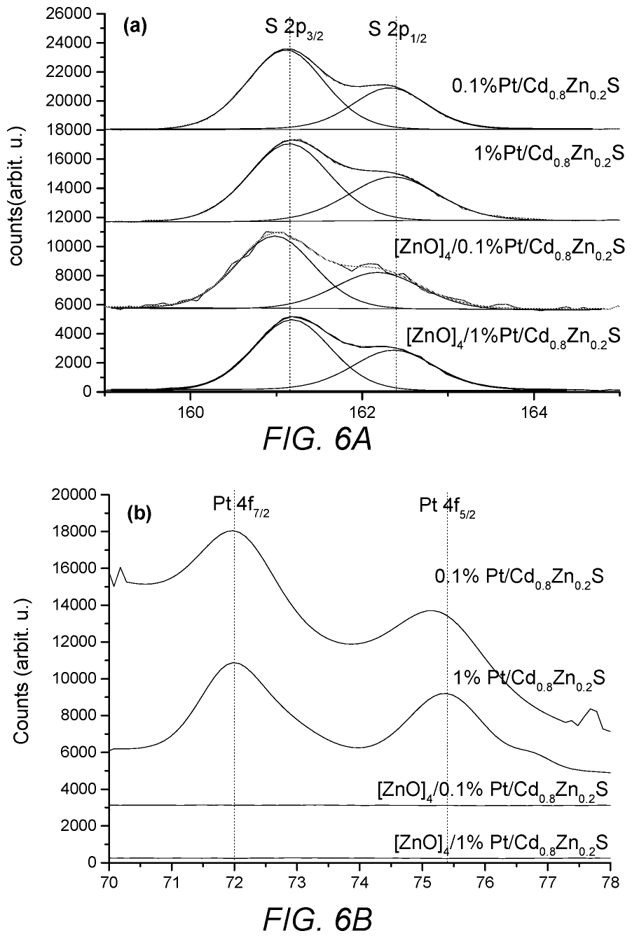

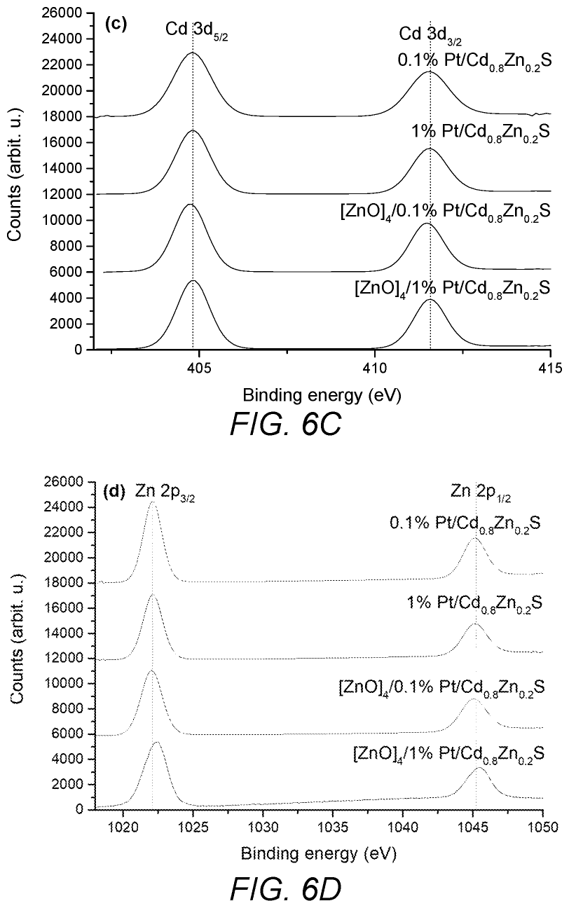

The range of binding energies of Zn 2p_{3/2} of all the Pt/CdZnS samples are between 1022.2±0.2 eV and were close to each other, which are similar to that of reported for ZnO¹⁷ and ZnS¹⁸ (FIG. 6D). The presence of metal oxide was verified by analyzing the chemical states of oxygen in the system. For example, the O1s peaks from Pt/Cd_{0.8}Zn_{0.2}S and ZnO/Pt/Cd_{0.8}Zn_{0.2}S showed three oxygen species in different chemical environments, where the peaks are at 530.0, 531.5 and 533.0 eV were ascribed to Zn—O, CH₃O—H (—OH) (from solvent) and H—O—H, respectively. Interestingly, the surface adsorbed water was only detected on the surface of none hybrid system such as 0.1% Pt/Cd_{0.8}Zn_{0.2}S and 1% Pt/Cd_{0.8}Zn_{0.2}S. Furthermore, the signal intensity of Zn—O became much weaker in the case of ZnO/1% Pt/Cd_{0.8}Zn_{0.2}S as compared to that of ZnO/0.1% Pt/Cd_{0.8}Zn_{0.2}S, which was interpreted in terms of encapsulation of ZnO by Cd_{0.8}Zn_{0.2}S in the hybrid systems. The S2p_{3/2} peaks of the samples were about 161.0 eV, characteristic of the presence of S²⁻ species on the surface²⁻ (FIG. 6A). Furthermore, none other species of sulfur is detected which indicates that S²⁻ was not oxidized during the synthesis. The peaks at around 404.7 eV in FIG. 6C corresponded to Cd3d_{5/2} and were ascribed to Cd—S bonds. The binding energies of Pt4f_{7/2} of the samples was almost identical (FIG. 6B). In general, the Pt4f_{7/2} binding energy of bulk metal platinum is around 71.1 eV, whereas the binding energy of Pt4f_{7/2} increased with decreasing the particle size of Pt. Then, the binding energy of Pt4f_{7/2} recorded at 72.0 eV indicated the presence of very small Pt particles on the surface, in accordance to high resolution TEM (FIGS. 5A-5D). From the ICP and XPS analysis, it was determined that Pt was sandwiched between ZnO and Cd(Zn)S as the 1 wt. % Pt, detected by ICP and TEM, was not detected by XPS in the same hybrid system, even though XPS could detect concentrations down to 0.1 wt. % Pt in the absence of ZnO (the non-hybrid system, FIG. 6B).

### Example 5

### Photocatalytic Tests

Photocatalytic reactions were performed in a 137-mL-volume Pyrex glass reactor using 6-30 mg of catalyst. 30 mL of various volume ratios of benzyl alcohol/acidic acid (BnOH/AcOH) aqueous solutions were used. The slurry was purged with N₂ gas to remove any O₂ and subjected to constant stirring before the reaction. The reactor was then exposed to UV light (100 Watt ultraviolet lamp H-144GC-100 Sylvania par 38 with a flux of 5 mW cm⁻² at a distance of 5 cm). Similarly, to evaluate the UV+visible light activity a Xenon lamp (Asahi spectra MAX-303) with a total flux of 42.5 mW cm⁻² (UV·3.0 mW cm⁻² and visible (up to 650 nm) at a distance of 2 cm was used. Product analyses were performed by a gas chromatograph (GC) equipped with thermal conductivity detector (TCD) connected to Porapak Q packed column (2 m) at 45° C. and N₂ was used as a carrier gas. Apparent quantum yield (AQY) at various wavelengths defined by equation (1) were calculated by data obtained using monochromatic LED (365 nm to 750 nm) at the distance of 2 cm. The corresponding light intensities were measured with a GL Spectics 5.0 Touch.

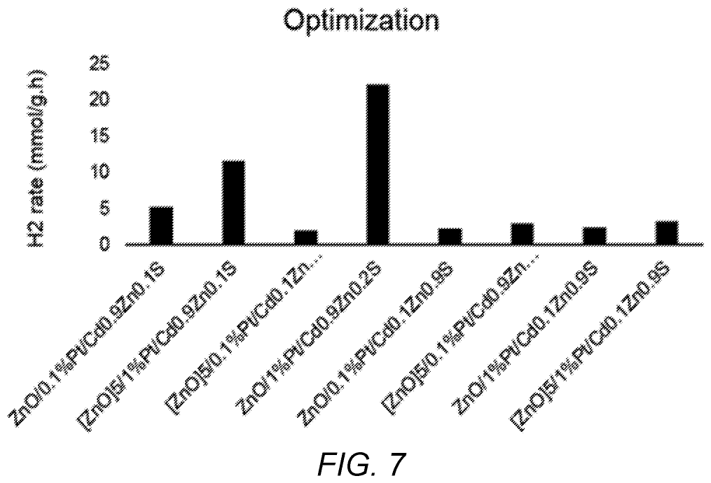

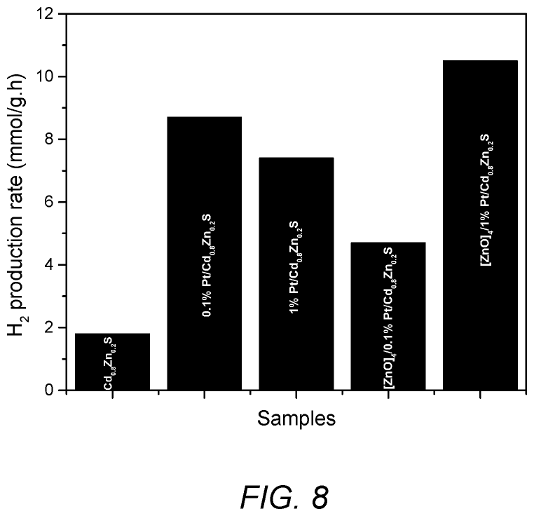

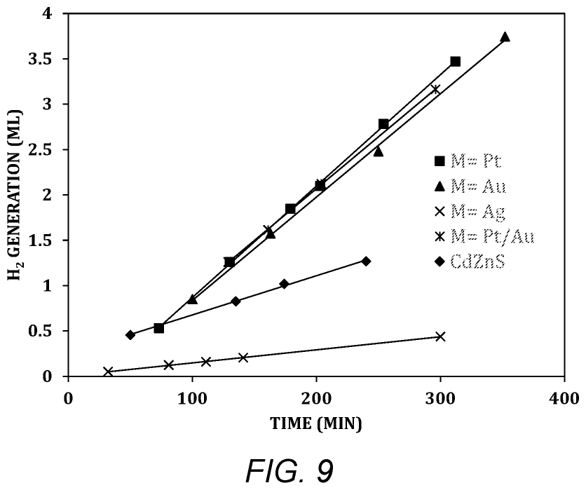

FIG. 7 shows hydrogen production rate (mmol/g.h) for (left to right): 1) ZnO/0.1 wt. % Pt/Cd_{0.9}Zn_{0.1}S; 2) [ZnO]₅/1 wt. % Pt/Cd_{0.9}Zn_{0.1}S; 3) [ZnO]₅/0.1 wt. % Pt/Cd_{0.1}Zn_{0.9}S; 4) [ZnO]₁/1 wt. % Pt/Cd_{0.9}ZnO_{0.2}S; 5) [ZnO]₁/0.1 wt. % Pt/Cd_{0.1}Zn_{0.9}S; 6) [ZnO]₅/0.1wt. % Pt/Cd_{0.9}ZnO_{0.1}S; 7) [ZnO]₁/1 wt. % Pt/Cd_{0.1}ZnO_{0.9}S; and 8) [ZnO]₅/1 wt. % Pt/Cd_{0.1}Zn_{0.9}S. FIG. 8 shows the hydrogen production rate (mmol/g.h) for (left to right): 1) Cd_{0.8}Zn_{0.2}S; 2) 0.1wt. % Pt/Cd_{0.8}Zn_{0.2}S; 3) 1 wt. % Pt/Cd_{0.8}Zn_{0.2}S; 4) [ZnO]₄/0.1 wt. % Pt/Cd_{0.8}Zn_{0.2}S; and 5) [ZnO]₄/1 wt. % Pt/Cd_{0.8}Zn_{0.2}S. FIG. 9 shows moles of H₂/g_{cat} over time using 7 mg of a Pd—Au, Pt, and Ag—Cd(Zn)S system catalyst. The hydrogen generation rates of ZnO/Au/Cd(Zn)S, ZnO/Pd—Au/Cd(Zn)S, and ZnO/Pt/Cd(Zn)S are almost identical. However, these rates are significantly higher than those of ZnO/Ag/Cd(Zn)S (as well as the systems without metals). Thus, Au and Pd—Au were determined to be suitable replacements for Pt. From the data ZnO/1% Pt/Cd_{0.9}Zn_{0.2}S (normalized to ZnO/1% Pt/Cd_{0.82}Zn_{0.1}S) produced hydrogen production rate at the highest rate of the tested systems. This is believed to be to the effect of the Z-scheme between ZnO and Cd_{0.9}Zn_{0.2}S through Pt. No H₂ was detected when Pt/ZnO alone was used even after 5 h of irradiation, suggesting that ZnO was not stable under pH=2.5. However, ZnO/Pt/Cd_{0.8}Zn_{0.2}S showed good stability and better activity under such a condition due to the encapsulation of ZnO by Cd_{0.8}Zn_{0.2}S. To study the effect of each component of ZnO/Pt/Cd_{0.8}Zn_{0.2}S on the Z-scheme, different combinations of ZnO, Pt and Cd_{0.8}Zn_{0.2}S were prepared (Pt/ZnO and Pt/Cd_{0.8}Zn_{0.2}S). The hydrogen generation activities in broad light spectrum (360-700 nm) and the corresponding quantum yields at 365 nm and 460 nm were compared to those of ZnO/Pt/Cd_{0.8}Zn_{0.2}S. Both ZnO/Pt/Cd_{0.8}Zn_{0.2}S and Pt/Cd_{0.8}Zn_{0.2}S showed much higher hydrogen generation rates than that of Cd_{0.8}Zn_{0.2}S regardless the quantity of Pt. This was believed to arise from the increase in charge-separation efficiency because of the electron transfer from the semiconductor to Pt. In addition, the photocatalytic activity of [ZnO]₄/1% Pt/Cd_{0.8}Zn_{0.2}S was around 50% higher than that of 1% Pt/Cd_{0.8}Zn_{0.2}S, which was attributed to the positive contribution of ZnO to the photoactivity. In order to quantify the actual contribution of ZnO, the AQY of both photocatalysts were measured using the same quantities present in the hybrid system (Table 4). Table 3 lists the AQY % of CdZnS based system under various illumination wavelengths for Cd_{0.8}Zn_{0.2}S series (CdZnS) based on the equation below

$$AQY \% = \frac{Number of excited electron}{The number of incident photon} = \frac{2 \times The number of evolved hydrogen molecules}{The number of indident photon}$$

TABLE 4

| | | Apparent | | Apparent |
|---|---|---|---|---|
| | Wave- | quantum | Wave- | quantum |
| | length | yield | length | yield |
| Catalysts | (nm) | (AQY %) | (nm) | (AQY %) |
| CdZnS | 365 | 3 | 460 | 9 |
| 0.1% Pt/CdZnS | 365 | 20 | 460 | 16 |
| 1% Pt/CdZnS | 365 | 14 | 460 | 10 |
| [ZnO]₄/0.1% Pt/CdZnS | 365 | 11 | 460 | 10 |
| [ZnO]₄/1% Pt/CdZnS | 365 | 34 | 460 | 16 |

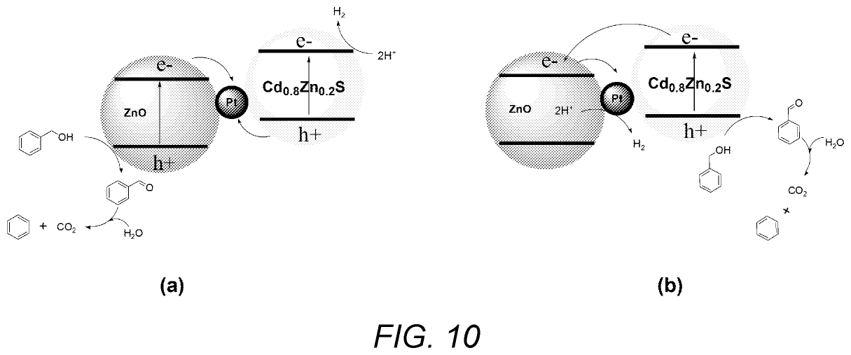

The maximum hydrogen rate of [ZnO]₄/1% Pt/Cd_{0.8}Zn_{0.2}S was obtained with 33 mg of catalyst in 30 mL of sacrificial reagent (33 mg cat/30 mL sac.), which contained 10 mg of Cd_{0.8}Zn_{0.2}S and 23 mg of ZnO, respectively. From the data, it was determined that when the catalysts were illuminated at 365 nm, where both ZnO and Cd_{0.8}Zn_{0.2}S were activated at the same time, the AQY of [ZnO]₄/1% Pt/Cd_{0.8}Zn_{0.2}S (33 mg/30 mL) was over two times higher than that of 1% Pt/Cd_{0.8}Zn_{0.2}S (10 mg/30 mL), while 1% Pt/ZnO did not produce any hydrogen. Therefore, it was concluded that the [ZnO]₄/1% Pt/Cd_{0.8}Zn_{0.2}S hybrid system followed a Z-scheme mechanism at 365 nm as shown in FIG. 10. In this case, the Z-scheme simultaneously generates VB-hole on ZnO with higher oxidation potential and CB-electron on Cd_{0.8}Zn_{0.2}S with higher reduction potential compared to that of ZnO and Cd_{0.8}Zn_{0.2}S. Consequently, the maximum redox potentials of the hybrid system were utilized, therefore resulting in higher photocatalytic activities. Interestingly, significantly higher AQY was also obtained by ZnO₄/1% Pt/Cd_{0.8}Zn_{0.2}S compared to that of 1% Pt/Cd_{0.8}Zn_{0.2}S when both catalysts were illuminated at 460 nm (Table 3). Although only the Cd_{0.8}Zn_{0.2}S portion of [ZnO]₄/1% Pt/Cd_{0.8}Zn_{0.2}S was exited at 460 nm, higher AQY was achieved likely because the photo generated electrons from the CB of Cd_{0.8}Zn_{0.2}S were relocated to the CB of ZnO and then transferred to Pt, resulting in a better charge separation, which in turn led to higher activity. In contrast, deactivations were observed both at 365 nm and 460 nm for [ZnO]₄/0.1% Pt/Cd_{0.8}Zn_{0.2}S verses the 0.1% Pt/Cd_{0.8}Zn_{0.2}S (Table 3), which implied the impotency of Pt content in the hybrid system.

A proposed charge transfer mechanisms for the photocatalysts of the present invention are shown in FIGS. 10A and 10B. Without wishing to be bound by theory, it is believed that the overall solar driving Z-scheme involved four steps as described in FIG. 10A.

The steps are believed to be (1) charge generation in ZnO and Cd_{0.8}Zn_{0.2}S, (2) charge recombination on Pt, (3) oxidation of sacrificial reagent on the VB of ZnO and (4) hydrogen generation on CB of Cd_{0.8}Zn_{0.2}S. This process only happens when both semiconductors are activated at the same time. On the other hand, simple charge transfer happens when only Cd_{0.8}Zn_{0.2}S is excited as shown in FIG. 10B. The charge transfer process was also associated to four steps, such as (1) Cd_{0.8}Zn_{0.2}S excitation, (2) electron transfer from Cd_{0.8}Zn_{0.2}S to ZnO and then Pt, (3) photooxydation on Cd_{0.8}Zn_{0.2}S and photo reduction on Pt. In summary, the Z-scheme (FIG. 10A) is formed under UV+Vis, while charge separation (FIG. 10B) occurs under visible light on ZnO/1% Pt/Cd(Zn)S.

Femtosecond transient absorption (TA) analysis. To further validate the proposed mechanism, femtosecond transient absorption (TA) measurements were performed on ZnO, ZnO/Pt, Cd_{0.8}Zn_{0.2}S, Cd_{0.8}Zn_{0.2}S/Pt, and ZnO/Pt/Cd_{0.8}Zn_{0.2}S. Time-resolved absorption decays were measured with a pump-probe setup, in which a white light continuum probe pulse was generated in a 2 mm thick sapphire plate contained in an Ultrafast System LLC spectrometer using few microjoules energy of 800-nm pulse. The fundamental output delivered by a Ti:sapphire femtosecond regenerative amplifier operating at 800 nm with 35 fs pulses and a repetition rate of 1 kHz. Spectrally tunable (240-2600 nm) femtosecond pulses generated by an Optical Parametric Amplifier (Light Conversion LTD) and a white light continuum were used, respectively, as the pump (excitation) and probe beams in a pump-probe experimental setup (Helios).

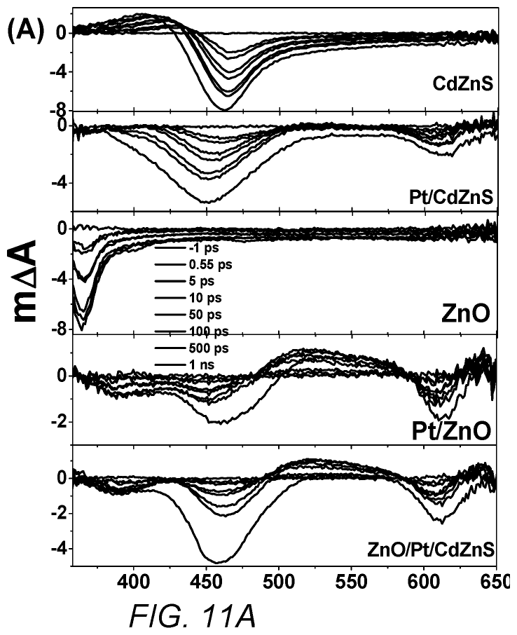

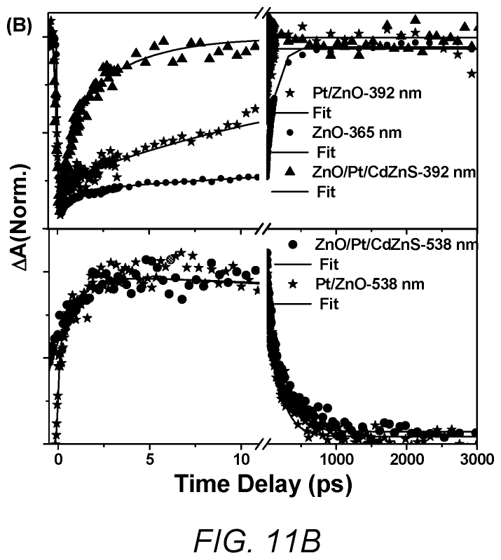

FIGS. 11A and 11B show the obtained data following 350-nm excitation. FIG. 11A are fs Transient absorption spectra of CdZnS, Pt/CdZnS, ZnO, Pt/ZnO, and ZnO/Pt/CdZnS in water at different time delay following 350 nm lase excitation, and FIG. 11B are Normalized kinetics traces monitored at key wavelength of ZnO, Pt/ZnO, and ZnO/Pt/CdZnS and normalized kinetic decay traces of ZnO, Pt/ZnO, and ZnO/Pt/Cd_{0.8}Zn_{0.2}S in 0.5 mg/ml water suspension following 350 nm excitation with 90 μJ/cm². The spectral features of Cd_{0.8}Zn_{0.2}S in terms of peak shapes and positions were similar to those observed in CdS²⁴ and were assigned in the same manner. The TA feature around 420 nm decayed rapidly, which was attributed to hot excitons in Cd_{0.8}Zn_{0.2}S²⁵. This feature disappeared in Cd_{0.8}Zn_{0.2}S/Pt due to fast electron transfer from Cd_{0.8}Zn_{0.2}S to Pt. The transient bleach (TB) around 470 nm showed slow decay, indicating the domination of long-lived single exciton state, and it was attributed to the filling of the electron level, which was broadened when Pt was attached to Cd_{0.8}Zn_{0.2}S. Meanwhile, a fast TB feature at 610 nm appeared, suggesting electron transfer from CB of Cd_{0.8}Zn_{0.2}S to Pt²⁶. A similar feature at slightly different position (615 nm) was also observed in the case of ZnO/Pt and further indicated that Pt nanoparticles were the main exciton quenching pathway²⁵. In addition, the broad TB features at 392 and 460 nm were attributed to electron absorption from shallow trap (ST) states of ZnO, while the broad photo induced absorption (PA) peak at 538 nm were assigned to hole absorption in ZnO/Pt. It is interesting to note that only one long-lived and high-energy exciton band was observed at 365 nm in pristine ZnO, representing a band absorption of 3.2 eV, which was dissociated into electrons and holes by Pt.

Although TB signals at 470 nm and 610 nm of Cd_{0.8}Zn_{0.2}S were stronger, overlapping signals with that of ZnO/Pt around same region made it difficult to analyze (FIG. 10A). Therefore, the TB feature at 390 nm and PA at 538 nm of ZnO were chosen to monitor the effect of Z-scheme (FIG. 11B). All the transient features of the ZnO/Pt, ZnO/Pt/Cd_{0.8}Zn_{0.2}S at various wavelengths were fitted with bi-exponential and the relevant fitted parameters are summarized in Table 5 (the fast, and slow charge carrier lifetime of ZnO/Cd_{0.8}Zn_{0.2}S based system at 350 excitation with 90 μJ/cm²). The electron feature of ZnO/Pt/Cd_{0.8}Zn_{0.2}S at 392 nm showed faster decay compared to that of ZnO/Pt, while the hole feature at 538 nm displayed negligible change in both ZnO/Pt/Cd_{0.8}Zn_{0.2}S and ZnO/Pt (FIG. 11B). This indicated faster depopulation of ST electron of ZnO through Z-scheme. According to the proposed mechanism as shown in FIGS. 10A and 10B, the electron generated on ZnO was quenched with the hole generated on Cd_{0.8}Zn_{0.2}S through Pt, which resulted in faster electron decay compared to that of ZnO/Pt. On the other hand, the lifetime of the hole was not affected that much. Consequently, this process made it possible for the electron from Cd_{0.8}Zn_{0.2}S and the hole from ZnO to participate in red-ox reactions. This kind of carrier dynamics features agreed with the description of Z-scheme as shown in FIGS. 10A and 10B.

TABLE 5

| System (λ, nm) | τ₁ (ps) | | τ₂ (ps) | |
|---|---|---|---|---|
| ZnO (365 nm) | 34.9 ± 3.3 | (63%) | 634.2 ± 90.6 | (37%) |
| PtZnO (392 nm) | 0.2 ± 0.05 | (40%) | 19.1 ± 2 | (60%) |
| ZnO/Pt/CdZnS (392 nm) | 0.118 ± 0.05 | (73%) | 2.5 ± 0.1 | (27%) |
| Pt/ZnO (538 nm) | 1 ± 0.06 | (32%) | 202.6 ± 28.3 | (−68%) |
| ZnO/Pt/CdZnS (538 nm) | 1 ± 0.07 | (33%) | 201 ± 25.8 | (−67%) |

1. A water splitting photoelectrochemical (PEC) catalyst comprising metal (M1) nanostructures positioned between a CdₓZn₁₋ₓS semiconductor and a ZnO semiconductor to form a Z-scheme catalyst having the structure ZnO/M1/CdₓZn₁₋ₓS, where x is less than 1.

2. The PEC catalyst of claim 1, wherein the M1 nanostructures comprise a transition metal.

3. The PEC catalyst of claim 3, wherein the M1 nanostructures comprise Pt, Ni, Cu, Fe, Au, Pd, or Ag or combinations thereof.

4. The PEC catalyst of claim 3, wherein the M1 nanostructures is Pt, AuPd, Au, or Pd.

5. The PEC catalyst of claim 2, wherein the M1 nanostructures are core-shell nanoparticles.

6. The PEC catalyst of claim 3, wherein the M1 nanostructures comprise Cu, Fe, Au, Pt, Pd, Ni, Ag metals, alloys of two or three metals, or core-shell nanostructures.

7. The PEC catalyst of claim 1, wherein the ZnO to M1 nanostructure ratio is 50:1 to 1000:1.

8. The PEC catalyst of claim 1, wherein ZnO to S ratio is 4:1 to 1:2.

9. The PEC catalyst of claim 1, wherein the catalyst is ZnO/1 wt. % Pt/Cd0.82Zn_{0.1}S or [ZnO]₄/1 wt. % Pt/Cd_{0.9}Zn_{0.1}S.

10. A photocatalytic reactor comprising a reactor having an inlet for feeding water or aqueous solution to a reactor chamber, the reaction chamber comprising:
(i) a photo electrochemical (PEC) assembly comprising a PEC photocatalyst of any one of claims 1 to 8;
(ii) a H₂ gas product outlet; and
(iii) O₂ gas product outlet.

11. The reactor of claim 9, wherein the CdₓZn₁₋ₓS semiconductor is deposited on a conductive support.

12. The reactor of claim 11, wherein the conductive support has a base coat of a hydrogen catalyst.

13. The reactor of claim 12 wherein the hydrogen catalyst comprises Pt, Pd, Au, Ag, Ir, Ru, Rh, Mo, Ni, Ce, Co, Fe, W, Sn, and combinations thereof.

14. The reactor of claim 13, wherein the catalyst comprises two metals at a ratio of between 10:1 to 1:10.

15. The reactor of claim 11, wherein the conductive support can be a stainless steel, molybdenum, titanium, tungsten, or tantalum, or combinations thereof.

16. The reactor of claim 10, wherein the ZnO semiconductor further comprises a hole transporting thin film.

17. The reactor of claim 10, further comprising an oxygen co-catalyst comprising a metal oxide having the general formula of AO_{y} or B_{z}N_{1-z}O_{y}, where A and B are metals, and z is <1 and y is a value that balances the valence of the oxide.

18. The reactor of claim 17, wherein the oxygen co-catalyst is a nickelate (IrNiO₃).

19. A method of producing hydrogen comprising irradiating a photo electrochemical (PEC) thin film with light in the presence of water, the PEC thin film comprising the photocatalyst of claim 1.

20. The method of claim 19, wherein the metal nanoparticle is Pt, Au, Pd, Ni, Fe, Cu, or Ag; alloys of two or three metals; or core-shell nanostructures.
